(19) United States
(12) Patent Application Publication
(10) Pub. No.: US 2011/0185872 A1
(43) Pub. Date: Aug. 4, 2011

(54) REPETITIVE STROKE WORK SYSTEM

(76) Inventors: Assaf Malul, Jerusalem (IL); Yehuda Malul, Queens, NY (US)

(21) Appl. No.: 12/295,732

(22) PCT Filed: Jan. 1, 2008
(86) PCT No.: PCT/IL08/00009

§ 371 Date: Oct. 2, 2008

Related U.S. Application Data
(60) Provisional application No. 60/939,372, filed on May 22, 2007.
(60) Provisional application No. 60/979,873, filed on Oct. 15, 2007.

(51) Int. Cl. B26D 7/02; B26F 1/04; B26D 7/26

(52) U.S. Cl. 83/468.6; 83/618; 83/641; 83/549; 83/467.1

(57) ABSTRACT

Disclosed is a repetitive stroke work system having an upper holder assembly configured to hold one or more work performing elements deployed on the upper holder assembly. The work performing elements are configured for lockable displacement on the upper holder assembly, with the displacement being along both X and Y axis relative to the upper holder assembly. The repetitive stroke work system also includes a workpiece repetitive positioning device configured with at least one initial work stop for use while performing an initial work operation and at least one subsequent work stop for use while performing subsequent work operations. The upper holder assembly is displaceable along a Z axis so as to bring the work performing elements in to operational contact with a workpiece deployed on the workpiece repetitive positioning device.

### RELATED APPLICATIONS

The above-referenced patent application is a National Phase application of PCT/IL2008/000009 filed on Jan. 1, 2008, and also claims priority under 37 U.S.C. §119(e) of U.S. Provisional Application No. 60/979,873 filed on Oct. 15, 2007, still pending and U.S. Provisional Application No. 60/939,372 filed on May 22, 2007, which has expired.

### FIELD AND BACKGROUND OF THE INVENTION

The present invention relates to punch press machines and, in particular, it concerns a repetitive stroke work system that includes an easily adjustable holder for multiple work performing elements and a workpiece repetitive positioning device.

It is known that punching holes is generally a faster and less expensive operation than milling and laser cutting. However, the punching process requires highly accurate positioning, which historically required a skilled operator performing only one hole per stroke. Simultaneous multiple hole punching procedures have been limited to job specific punch assemblies and changing the position of individual punches for a different job is a labor intensive and time intensive task.

When using a machine to perform a task on a workpiece, such as drilling, cutting, bending, or punching a hole, it is also known to provide a positioning or holding device to ensure accurate positioning of the workpiece before performing the task. In many such operations the work to be performed is divided into two or more major steps: Work performed on the edge of the material, such as the first set of holes, and the following set of operations, usually performed in equally-spaced intervals.

In many situations when using a power tool, it is necessary to make several operations of different dimensions requiring the operator to reset a positioning device or movable stop relative to the tool many times. Re-setting the machine generally requires a highly skilled operator and is time-consuming. Therefore, the work is usually processed in several stages: performing a first task on all the material using the initial settings; then changing the setting and performing a second task on all the material, and so on, until the job is completed. This requires the operator to load and unload each workpiece for each task, which is time consuming and can be less accurate.

There are two major types of solutions available today for this type of operation. One solution is a variety of computerized or otherwise automated power tools such as CNC machines. These machines can perform any kind of repetitive operation such as cutting holes in regular or irregular intervals, etc. This type of machine is very expensive, and affordable only to large manufacturers. These systems are also physically very large, requiring a large area of factory floor space, and can only be operated by trained skilled operators.

The other solution is a production line consisting of a variety of task specific devices which enable setting a fixed set of stops on the workbench. This solution is very well suited for producing one type of finished product. However, the re-tooling required to switch to a different product is both labor and time intensive.

There is therefore a need for a repetitive stroke work system that includes an easily adjustable holder for multiple work performing elements and a workpiece repetitive positioning device.

### SUMMARY OF THE INVENTION

The present invention is a repetitive stroke work system that includes an easily adjustable holder for multiple work performing elements and a workpiece repetitive positioning device.

According to the teachings of the present invention there is provided, a repetitive stroke work system comprising: a) an upper holder assembly configured to hold one or more work performing elements deployed on the upper holder assembly, the work performing elements configured for lockable displacement on the upper holder assembly, the displacement being along both X and Y axis relative to the upper holder assembly; and b) a workpiece repetitive positioning device configured with at least one initial work stop for use while performing an initial work operation and at least one subsequent work stop for use while performing subsequent work operations; wherein the upper holder assembly is displaceable along a Z axis so as to bring the work performing elements in to operational contact with a workpiece deployed on the workpiece repetitive positioning device.

According to a further teaching of the present invention, the upper holder assembly includes: a) an upper base plate; and b) an upper element holding plate displaceably attached to the upper base plate and configure to hold the work performing elements; wherein the upper element holding plate is displaceable on the upper base plate along one of the X and Y axes and the work performing elements are displaceable on the upper element holding plate along the other of the X and Y axes.

According to a further teaching of the present invention, there is also provided a lower holder assembly configured for holding one or more complementary work elements deployed thereon, the complementary work elements configured for lockable displacement on the lower holder assembly so as to be operationally aligned with the work performing elements, the displacement being along both X and Y axis relative to the lower holder assembly wherein the upper holder assembly is displaceable along a Z axis so as to bring the work performing elements in to operational contact with the complementary work elements.

According to a further teaching of the present invention, the lower holder assembly includes: a) a lower base plate; and b) a lower element holding plate displaceably attached to the lower base plate and configured to hold the complementary work elements; wherein the lower element holding plate is displaceable on the lower base plate along one of the X and Y axes and the complementary work elements are displaceable on the lower element holding plate along the other of the X and Y axes.

According to a further teaching of the present invention, there is also provided at least one initial work stop for performing an initial work operation and at least one subsequent work stop for performing subsequent work operations wherein after completion of the initial work operation, the initial work stop is retracted so as to provide access to the subsequent work stop, the initial work stop and the subsequent work stop being configured for lockable displacement on the workpiece repetitive positioning device, the displacement being along both X and Y axis relative to the workpiece repetitive positioning device.

According to a further teaching of the present invention, there is also provided at least one work stop holding plate displaceably attached to the workpiece repetitive positioning device and configured to hold at least one of the initial work stop and the subsequent work stop, wherein the work stop holding plate is displaceable on the workpiece repetitive positioning device along one of the X and Y axes and at least one of the initial work stop and the subsequent work stop is displaceable on the work stop holding plate along the other of the X and Y axes.

According to a further teaching of the present invention, at least one of the initial work stop and the subsequent work stop is biased to a raised position.

There is also provided according to the teachings of the present invention, an adjustable holder for multiple work performing elements comprising an upper holder assembly configured for holding one or more work performing elements deployed thereon, the work performing elements configured for lockable displacement on the upper holder assembly, the displacement being along both X and Y axis relative to the upper holder assembly, the holder assembly being displaceable along a Z axis.

According to a further teaching of the present invention, the upper holder assembly includes: a) an upper base plate; and b) an upper element holding plate displaceably attached to the upper base plate and configure to hold the work performing elements; wherein the upper element holding plate is displaceable on the upper base plate along one of the X and Y axes and the work performing elements are displaceable on the upper element holding plate along the other of the X and Y axes.

According to a further teaching of the present invention, there is also provided a lower holder assembly configured for holding one or more complementary work elements deployed thereon, the complementary work elements configured for lockable displacement on the lower holder assembly so as to be operationally aligned with the work performing elements, the displacement being along both X and Y axis relative to the lower holder assembly wherein the upper holder assembly is displaceable along a Z axis so as to bring the work performing elements in to operational contact with the complementary work elements.

According to a further teaching of the present invention, the lower holder assembly includes: a) a lower base plate; and b) a lower element holding plate displaceably attached to the lower base plate and configured to hold the complementary work elements; wherein the lower element holding plate is displaceable on the lower base plate along one of the X and Y axes and the complementary work elements are displaceable on the lower element holding plate along the other of the X and Y axes.

There is also provided according to the teachings of the present invention, a workpiece repetitive positioning device comprising at least one initial work stop for performing an initial work operation and at least one subsequent work stop for performing subsequent work operations, the initial work stop and the subsequent work stop being configured for lockable displacement on the workpiece repetitive positioning device, the displacement being along both X and Y axis relative to the workpiece repetitive positioning device.

According to a further teaching of the present invention, there is also provided at least one work stop holding plate displaceably attached to the workpiece repetitive positioning device and configured to hold at least one of the initial work stop and the subsequent work stop, wherein the work stop holding plate is displaceable on the workpiece repetitive positioning device along one of the X and Y axes and at least one of the initial work stop and the subsequent work stop is displaceable on the work stop holding plate along the other of the X and Y axes.

There is also provided according to the teachings of the present invention, a workpiece repetitive positioning device comprising at least one initial work stop for performing an initial work operation and at least one subsequent work stop for performing subsequent work operations wherein after completion of the initial work operation the initial work stop is retracted so as to provide access to the subsequent work stop.

According to a further teaching of the present invention, at least one of the initial work stop and the subsequent work stop is biased to a raised position.

### BRIEF DESCRIPTION OF THE DRAWINGS

The invention is herein described, by way of example only, with reference to the accompanying drawings, wherein:

FIG. 1 is a schematic isometric top view of an adjustable holder for multiple punches constructed and operational according to the teachings of the present invention;

FIG. 2 is a schematic isometric bottom view of the embodiment of FIG. 1;

FIG. 3 is a schematic isometric view of the embodiment of FIG. 1 showing only the punch elements, the die holder portion and a workpiece;

FIG. 4 is a schematic isometric front view of a workpiece repetitive positioning device constructed and operational according to the teachings of the present invention shown here with the die holder in place;

FIG. 5 is a schematic isometric rear view of the embodiment of FIG. 4;

FIG. 6 is a schematic isometric front view of the embodiment of FIG. 4 shown here without the die holders;

FIG. 7 is a schematic isometric view of the embodiment of FIG. 4 shown here fully assembled with workpiece support elements, a workpiece and punch elements.

### DESCRIPTION OF THE PREFERRED EMBODIMENTS

The present invention is a repetitive stroke work system that includes an easily adjustable holder for multiple work performing elements and a workpiece repetitive positioning device.

The principles and operation of repetitive stroke work system according to the present invention may be better understood with reference to the drawings and the accompanying description.

By way of introduction, the repetitive stroke work system of the present invention includes an easily adjustable holder for multiple work performing elements and a workpiece repetitive positioning device that when used together provide a degree of synergy not found in the prior art. Yet, each may be used individually.

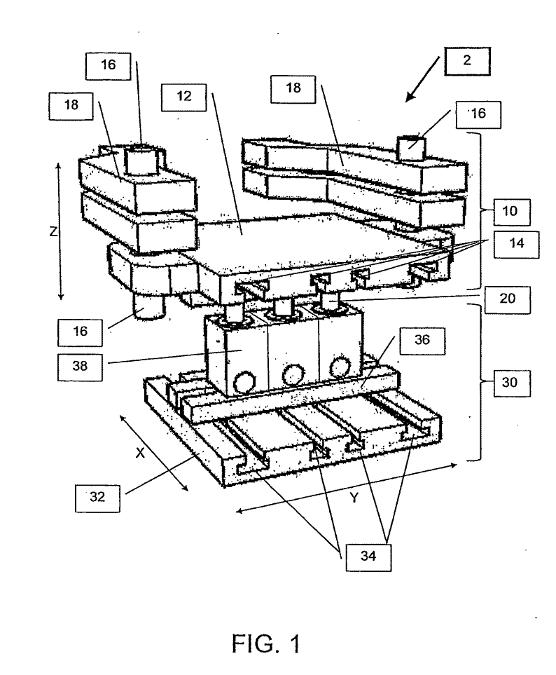

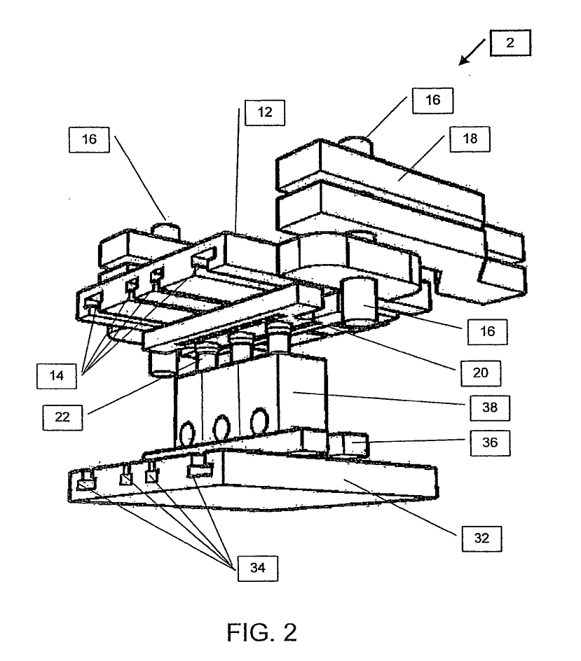

The adjustable holder for multiple work performing elements, which will be discussed in detail with regard to FIGS. 1-3, performs its operation fast, it is inexpensive, easy to use, and does not require experience to operate. The design of the preferred embodiment is simple and has a comparatively low number of parts, making it dependable and affordable. The device is designed to be small enough to be used in small workshops, but can be used by large manufacturing companies as well.

The adjustable holder for multiple work performing elements of the present invention is designed to enable a single hydraulic or other type of punch/press machine to perform multiple work operations on a workpiece in a single stroke. Although the embodiment described herein relates to punching holes in metal material, it will be appreciated that the principles of the present invention may be easily adapted for other repetitive work performed on substantially any material by means of a repetitive stroke such as, but not limited to, drilling, punching, bending and cutting of sheet metal, steel, iron, plastic, composite materials and wood.

The purpose of the adjustable holder for multiple work performing elements of the present invention is to provide ease of displacement of work performing elements, such as the exemplary punch elements described herein, along both the lateral (X) and perpendicular (Y) axis. To that end, the device includes holder assembly with a plurality of slots enabling sliding displacement of a plurality of work performing elements deployed therein and support elements along which the plate is displaceable along the Z axis in order to perform the repetitive stroke. This enables the user to adjust the position of each of the work performing elements according to the required hole positions and performing multiple holes in each repetitive stroke, thus saving valuable work time. It should be noted that although the Figures illustrate an embodiment in which the working stroke is vertical, this is not to be considered a limitation of the principles of the present invention and that embodiments in which the working stroke is horizontal or otherwise non-vertical is within the scope of the present invention.

It will be appreciated that the adjustable holder for multiple work performing elements of the present invention can be set by using pre-fabricated templates containing holes at the required positions, each template corresponding to a specific placement of holes required by a specific job. The template may be placed on the workbench, and the work performing elements are moved to the exact positions as indicated by the template. The operator then locks the work performing elements and the setting is done. It will be obvious that this type of setting can be performed by unskilled operators.

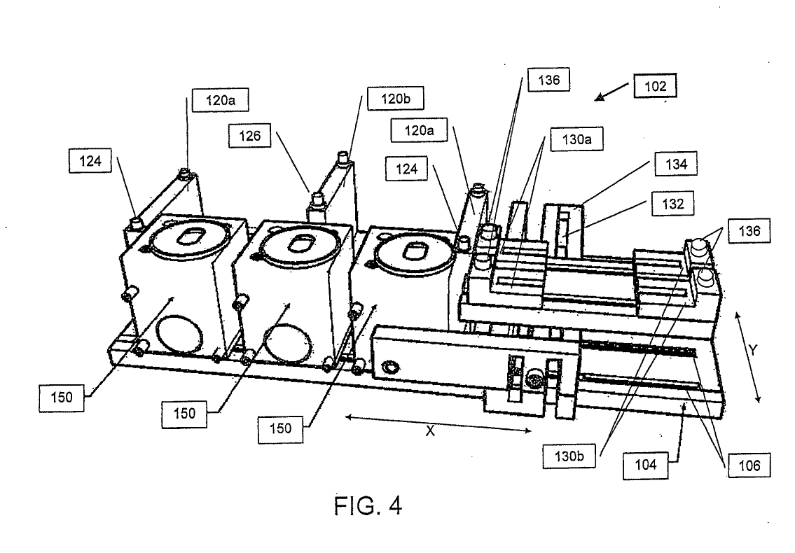

The adjustable holder for multiple work performing elements of the present invention is designed to provide a particular synergy when used in conjunction with the workpiece repetitive positioning device of the present invention, which will be discussed in detail with regard to FIGS. 4-7.

The workpiece repetitive positioning device of the present invention is highly accurate and easy to use and does not require extensive training or experience to accurately position a workpiece during a sequence of work operations. The design of the preferred embodiment is simple and has a comparatively low number of parts, making it dependable and affordable. Here too, the device is designed to be small enough to be used in small workshops, but can be used by large manufacturing companies as well.

The repetitive positioning device of the present invention is designed to enable precise positioning of a workpiece relative to a work performing element such as a power tool or other device for repetitive motion operations such as, but not limited to, punching regularly spaced holes, bending material at pre-determined spaced intervals, and drilling holes in substantially any suitable material such as, but not limited to, sheet metal, steel, iron, plastic, composite materials and wood. The repetitive positioning device includes a base with slots enabling sliding displacement of at least one, and preferably a plurality of, spring-loaded retractable work stops which are displaceable in both lateral (X) and perpendicular (Y) axis and one or more work performing elements such as, but not limited to, die holders, bending blocks or the like, which are displaceable in the lateral axis (X).

In the preferred embodiment of the repetitive positioning device of the present invention, the work stops are configured as spring-loaded retractable pins. A first set of stops is used to position the piece for performing the initial work operation, and another set is used to position subsequent, equally spaced work operations. After using the first set of stops in order to perform the initial work operation, the operator can place the workpiece over the first stops, compressing the springs by using the weight of the workpiece, thus compressing them into the bench and enabling the use of the second set of stops during the subsequent repetitive work operations.

The device can be set by using pre-fabricated templates containing holes at the required stop positions, with each template corresponding to a specific set of stop positions required by a specific job. The template may be placed on the workbench, and the stops are moved to the exact positions as indicated by the template. The operator then locks the stops in place, and the setting is done. Here too, it will be obvious that this type of setting can be performed by unskilled operators.

Referring now to the drawings, it should be noted that the use of directional terms such as “upper,” “lower,” “back” and “raised,” refer to the position of elements as they appear in the drawings and such terms are not to be considered as limitations to the scope of the present invention.

FIGS. 1-3 illustrate features of a preferred embodiment of an adjustable holder for multiple work performing elements constructed and operational according to the teachings of the present invention, generally referred to as 2. As illustrated here, the work performing elements are configured as hole punching elements 22.

This preferred embodiment includes an upper holder assembly 10 having an upper base plate 12 with slots 14 enabling sliding displacement along the Y axis of at least one upper element holding plate 20 that is displaceably attached to the upper base plate 12 via slots 14. The hole punching elements 22 are displaceably attached to the upper element holding plate 20 so as to be displaceable along the X axis. It will be appreciated that a plurality of upper element holding plates 20 may be simultaneously deployed on the upper base plate 12 via slots 14, thereby providing a variety of punch element arrangements.

The upper base plate 12 is displaceably mounted on guide bars 16 that are in turn held by arms 18 so as to be displaceable along the Z axis. Therefore, the entire upper holder assembly 10 is displaceable along the Z axis so as to perform the repetitive work stroke. It will be understood that guide bars 16 are used both to position the upper holder assembly 10 accurately, and to carry the torque that may develop during the punching operation of holes that are not directly below the hydraulic or mechanical ram of the punch machine (not shown) used to operate the repetitive stroke work system of the present invention.

This preferred embodiment further includes an lower holder assembly 30 having an lower base plate 32 with slots 34 enabling sliding displacement along the Y axis of at least one lower element holding plate 36 that is displaceably attached to the lower base plate 32 via slots 34. Die holders 38, configured with die elements that correspond to the hole punching elements 22, are displaceably attached to the lower element holding plate 36 so as to be displaceable along the X axis. It will be appreciated that a plurality of lower element holding plates 36 may be simultaneously deployed on the lower base plate 32 via slots 34 so as to enable deployment of die holders 38 aligned along the Y axis.

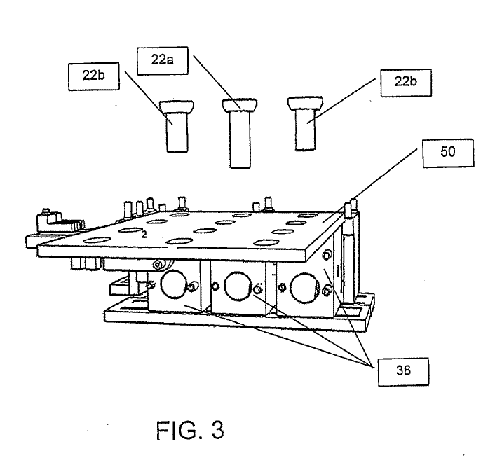

If the punching machine used to operate the repetitive stroke work system of the present invention is not powerful enough to punch all the required holes simultaneously due to lack of adequate power, a staggered-height punch holder arrangement may be used (See FIG. 3), whereby at least one hole punching element 22 is positioned at a different height, thus loading the punch machine with only the number of punches it can perform simultaneously and limiting the required power. As illustrated here, hole punching element 22a will contact the surface of the workpiece 50 before hole punching elements 22b. It will be appreciated that this feature is applicable to hydraulic machines, as well.

FIGS. 4-7 illustrate features of a preferred embodiment of a repetitive positioning device constructed and operational according to the teachings of the present invention, generally referred to as 102. For ease of continuity in understanding the principles of the present invention, the preferred embodiment of a repetitive positioning device is illustrated here with die holders 150 deployed on the base 104 so as to correspond to the discussion above relating to the adjustable holder for multiple work performing elements.

The preferred embodiment of a repetitive positioning device illustrated herein includes a base 104 having slots 106 enabling sliding displacement of at least one, and preferably a plurality of work stop elements having at least one spring-loaded, retractable component that is biased to a raised position. Two non-limiting examples of work stop elements are illustrated herein. Work stop elements 120 are used with regard to displacement of a workpiece parallel to the Y axis and work stop elements 130 are used with regard to displacement of a workpiece parallel to the X axis.

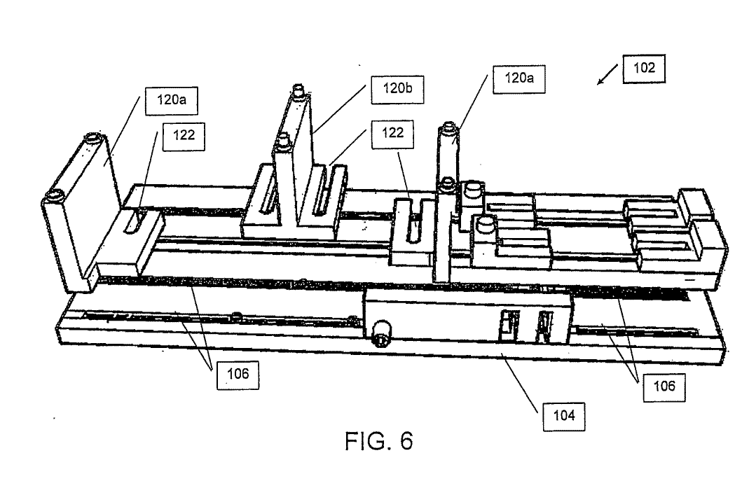

As seen best in FIG. 6, the combination of slots 106 in base 104 and the slots 122 configured in the work stop elements 120 provides positioning displacement of the work stop elements 120 along both the X and the Y axis. Like wise, positioning displacement of the work stop elements 130 along both the X and the Y axis is provided by the combination of slots 106 in base 104 and the slots 132 configured in the intermediate plate 134.

In this non-limiting example, the work stop elements 120 and 130 are configured with spring-loaded, retractable pins (124, 126, 136 and 138) that are biased to the raised position. When performing work operations requiring displacement of the workpiece parallel to the Y axis, work stop elements 120a may be used to position the workpiece for making the first set of holes, and work stop elements 120b may be used to position the workpiece in order to make subsequent holes. After using the first set of work stop elements 120a in order to make the first set of holes, the operator can lift the workpiece onto the retractable pins 124, compressing the springs by taking advantage of the weight of the workpiece, thus retracting pins 124 into work stop elements 120a and enabling the use of work stop element 120b during the subsequent, repetitive operations. It will be appreciated that additional sets of stop elements may be added if more than two different settings are required. Although the spring-loaded, retractable components of the present invention that are biased to the raised position are illustrated herein as pins (124, 126, 136 and 138), it will be appreciated that the principles of the present invention may be applied to components configured in substantially any suitable shape such as hinged wedges by non-limiting example.

Likewise, when performing work operations requiring displacement of the workpiece parallel to the X axis, work stop elements 130a may be used to position the workpiece for making the first set of holes, and work stop elements 130b may be used to position the workpiece in order to make subsequent holes. After using the first set of work stop elements 130a in order to make the first set of holes, the operator can lift the workpiece onto the retractable pins 136, compressing the springs by taking advantage of the weight of the workpiece, thus retracting pins 136 into work stop elements 130a and enabling the use of work stop element 130b during the subsequent, repetitive operations. It will be appreciated that additional sets of stops may be added if more than two different settings are required.

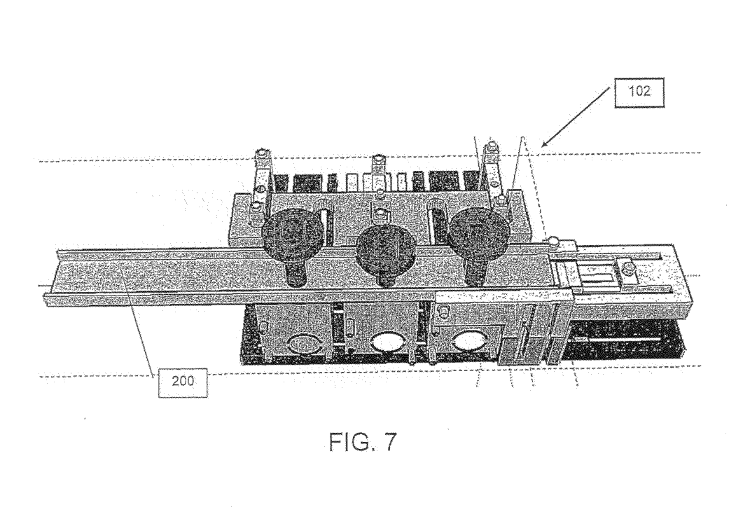

It will be appreciated that if the work specifications call for a series of equally spaced holes, work stop element 130b may use the inside surface of the holes already punched into the workpiece as an abutment surface, thus allowing the repetitive positioning of an elongated workpiece such as, but not limited to construction beam 200 illustrated in FIG. 7. Therefore, in each additional operational step, the previous hole in the workpiece 200 is placed on top of pins 138 and displaced parallel to the X axis until pins 138 raise into a hole in the workpiece. The workpiece 200 is then pressed against the stop, which acts as a guide to measure the required distance to the next set of holes.

It will be understood that here too, templates may be used for the quick and accurate positioning of the dies and the work stop elements.

Another feature of the present invention includes the spring-loaded retractable pins 124, 126, 136 and 138 that are configured so as to be lockable in their retracted position, thus allowing the deployment of multiple work stop element arrangement of the system for multiple jobs. The stops required for a particular job may be released in order to be used, and other stops are locked in the retracted position until they are needed. This prevents the user from having to re-set the system for different types of work, as long as the stops for that setup are deployed and have not been moved.

A variant embodiment of the repetitive positioning device of the present invention includes automatic raising and lowering of the retractable pins 124, 126, 136 and 138. It will be readily understood that electrical, pneumatic or other methods of power delivery may be used in order to raise or lower the stops in each separate work operation. Further, the automation may be varied for each separate job. This may speed up the process in some implementations, and make it unnecessary to depress the spring-loaded stops using the weight of the material.

An additional feature of the present invention includes a scale attached in appropriate locations of the device so as to enable the precise positioning of the spring-loaded retractable stops without requiring external measurements. These scales may have a fixed set of numbers indicating commonly used sets of distances. Additionally, an adjustable leveler may be placed in the rear of the die holder to keep the required level in order to compensate for leveling of the workpiece such as angle iron and I-beam.

Another feature of the present invention, not illustrated, includes a device for mounting base 104 to a power tool. Preferably, the mounting device enables sliding displacement of the base relative to a power tool.

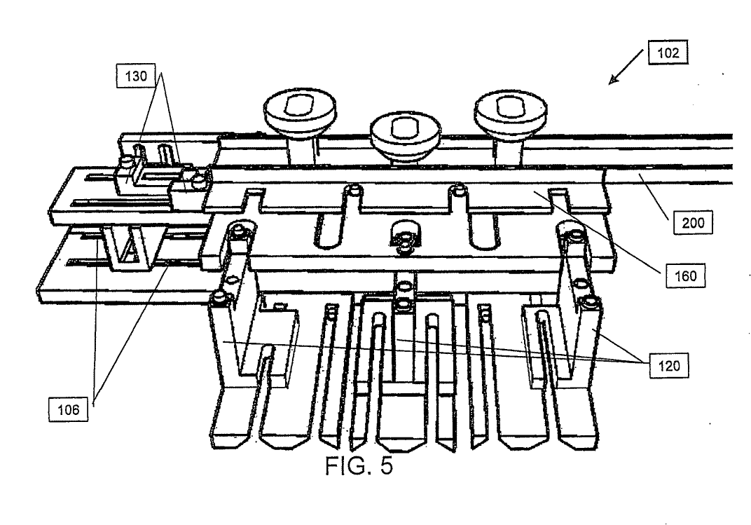

Still another additional feature of the invention includes a second movable plate 160 (see FIG. 5) is deployed as a guide to on the back side of the material so as to provide better control during the sliding motion of elongated material such as beams.

It will be understood that, as mentioned above, the die holders illustrated herein may be replaced by other suitable work performing elements such as but not limited to, a set of bending blocks, enabling use as a repetitive-motion positioning device for bending material such as metal plates or sheets, where different settings are required for the first bend and subsequent bending operations.

It will be appreciated that the above descriptions are intended only to serve as examples and that many other embodiments are possible within the spirit and the scope of the present invention.

What is claimed is:

1. A repetitive stroke work system comprising:
(a) an upper holder assembly configured to hold one or more work performing elements deployed on said upper holder assembly, said work performing elements configured for lockable displacement on said upper holder assembly, said displacement being along both X and Y axis relative to said upper holder assembly; and
(b) a workpiece repetitive positioning device configured with at least one initial work stop for use while performing an initial work operation and at least one subsequent work stop for use while performing subsequent work operations;
wherein said upper holder assembly is displaceable along a Z axis so as to bring said work performing elements in to operational contact with a workpiece deployed on said workpiece repetitive positioning device.

2. The repetitive stroke work system of claim 1, wherein said upper holder assembly includes:
(a) an upper base plate; and
(b) an upper element holding plate displaceably attached to said upper base plate and configure to hold said work performing elements;
wherein said upper element holding plate is displaceable on said upper base plate along one of the X and Y axes and said work performing elements are displaceable on said upper element holding plate along the other of the X and Y axes.

3. The repetitive stroke work system of claim 2, further including a lower holder assembly configured for holding one or more complementary work elements deployed thereon, said complementary work elements configured for lockable displacement on said lower holder assembly so as to be operationally aligned with said work performing elements, said displacement being along both X and Y axis relative to said lower holder assembly wherein said upper holder assembly is displaceable along a Z axis so as to bring said work performing elements in to operational contact with said complementary work elements.

4. The repetitive stroke work system of claim 3, wherein said lower holder assembly includes:
(a) a lower base plate; and
(b) a lower element holding plate displaceably attached to said lower base plate and configured to hold said complementary work elements;
wherein said lower element holding plate is displaceable on said lower base plate along one of the X and Y axes and said complementary work elements are displaceable on said lower element holding plate along the other of the X and Y axes.

5. The repetitive stroke work system of claim 1, further including at least one initial work stop for performing an initial work operation and at least one subsequent work stop for performing subsequent work operations wherein after completion of said initial work operation, said initial work stop is retracted so as to provide access to said subsequent work stop, said initial work stop and said subsequent work stop being configured for lockable displacement on the workpiece repetitive positioning device, said displacement being along both X and Y axis relative to the workpiece repetitive positioning device.

6. The repetitive stroke work system of claim 7, further including at least one work stop holding plate displaceably attached to the workpiece repetitive positioning device and configured to hold at least one of said initial work stop and said subsequent work stop, wherein said work stop holding plate is displaceable on the workpiece repetitive positioning device along one of the X and Y axes and at least one of said initial work stop and said subsequent work stop is displaceable on said work stop holding plate along the other of the X and Y axes.

7. The repetitive stroke work system of claim 7, wherein at least one of said initial work stop and said subsequent work stop is biased to a raised position.

8. An adjustable holder for multiple work performing elements comprising an upper holder assembly configured for holding one or more work performing elements deployed thereon, said work performing elements configured for lockable displacement on said upper holder assembly, said displacement being along both X and Y axis relative to said upper holder assembly, said holder assembly being displaceable along a Z axis.

9. The adjustable holder for multiple work performing elements of claim 8, wherein said upper holder assembly includes:
(a) an upper base plate; and
(b) an upper element holding plate displaceably attached to said upper base plate and configure to hold said work performing elements;
wherein said upper element holding plate is displaceable on said upper base plate along one of the X and Y axes and said work performing elements are displaceable on said upper element holding plate along the other of the X and Y axes.

10. The adjustable holder for multiple work performing elements of claim 8, further including a lower holder assembly configured for holding one or more complementary work elements deployed thereon, said complementary work elements configured for lockable displacement on said lower holder assembly so as to be operationally aligned with said work performing elements, said displacement being along both X and Y axis relative to said lower holder assembly wherein said upper holder assembly is displaceable along a Z axis so as to bring said work performing elements in to operational contact with said complementary work elements.

11. The adjustable holder for multiple work performing elements of claim 10, wherein said lower holder assembly includes:
(a) a lower base plate; and
(b) a lower element holding plate displaceably attached to said lower base plate and configured to hold said complementary work elements;
wherein said lower element holding plate is displaceable on said lower base plate along one of the X and Y axes and said complementary work elements are displaceable on said lower element holding plate along the other of the X and Y axes.

12. A workpiece repetitive positioning device comprising at least one initial work stop for performing an initial work operation and at least one subsequent work stop for performing subsequent work operations, said initial work stop and said subsequent work stop being configured for lockable displacement on the workpiece repetitive positioning device, said displacement being along both X and Y axis relative to the workpiece repetitive positioning device.

13. The workpiece repetitive positioning device of claim 12, further including at least one work stop holding plate displaceably attached to the workpiece repetitive positioning device and configured to hold at least one of said initial work stop and said subsequent work stop, wherein said work stop holding plate is displaceable on the workpiece repetitive positioning device along one of the X and Y axes and at least one of said initial work stop and said subsequent work stop is displaceable on said work stop holding plate along the other of the X and Y axes.

14. A workpiece repetitive positioning device comprising at least one initial work stop for performing an initial work operation and at least one subsequent work stop for performing subsequent work operations wherein after completion of said initial work operation said initial work stop is retracted so as to provide access to said subsequent work stop.

15. The workpiece repetitive positioning device of claim 13, wherein at least one of said initial work stop and said subsequent work stop is biased to a raised position.
